(19) United States
(12) Patent Application Publication
(10) Pub. No.: US 2008/0095361 A1
(43) Pub. Date: Apr. 24, 2008

(54) Security-Enhanced Key Exchange

(75) Inventors: Monica Wifvesson, Lund (SE); Christian Gehrmann, Lund (SE)

Correspondence Address: POTOMAC PATENT GROUP PLLC, P. O. BOX 270, FREDERICKSBURG, VA, 22404, US

(73) Assignee: Telefonaktiebolaget L M Ericsson (publ), Stockholm (SE)

(21) Appl. No.: 11/862,834

(22) Filed: Sep. 27, 2007

Related U.S. Application Data
(60) Provisional application No. 60/862,098, filed on Oct. 19, 2006.
(60) Provisional application No. 60/885,039, filed on Jan. 16, 2007.

(51) Int. Cl. H04L 9/28

(52) U.S. Cl. 380/44; 380/28

(57) ABSTRACT

A unique identifier of a remote device is not sent in clear text on a local interlace between the remote device and a device that can communicate with a wireless network, but a procedure for establishing an encryption key in both devices is still based on the unique identifier. Thus, secure binding between the established key and the identifier is achieved. Moreover, the identifier of the remote device is not exposed even to the device that can communicate with a wireless network.

This application claims the benefit of the filing dates of U.S. Provisional Patent Applications No. 60/862,098 filed on Oct. 19, 2006, and No. 60/885,039 filed on Jan. 16, 2007, both of which are expressly incorporated here by reference.

### BACKGROUND

User equipments (UEs), such as mobile telephones and other remote terminals, are provided in various wireless communication systems, including cellular radio telephone systems like the universal mobile telecommunications system (UMTS). The UMTS is a third generation (3G) mobile communication system being developed by the European Telecommunications Standards Institute (ETSI) within the International Telecommunication Union's (ITU's) IMT-2000 framework. The UMTS employs wideband code division multiple access (WCDMA) for the air interfaces between UEs and base stations (BSs) in the system. The Third Generation Partnership Project (3GPP) promulgates specifications for the UMTS and WCDMA systems. This application focusses on 3GPP communication systems simply for economy of explanation, and the artisan will understand that the principles described in this application can be implemented in other communication systems. 3GPP Technical Specification (TS) 22.259 V8.1.0, Service Requirements for Personal Network Management (PNM); Stage 1 (Release 8) (September 2006) and its earlier versions specifies service requirements that allow users to manage their Personal Network Elements (PNEs) and Personal Area Networks (PANs). A PAN is generally a local network of a user that includes at least one UE and may additionally include a number of Mobile Equipments (MEs) and/or Mobile Terminals (MTs) that have their own radio access means that allow them to directly access the Public Land Mobile Network (PLMN) of the UE. The UE and locally connected MEs/MTs can be PNEs of the PAN, or the UE components, i.e., TEs and MTs, may be handled as separate PNEs. The UE contains the PAN's single active Universal Subscriber Identity Module (USIM), which is information that resides on a Universal Integrated Circuit Card (UICC) and that is used for accessing services provided by the UE's PLMN and other mobile networks on which the application is able to register with the appropriate security. A UICC is generally either a physically secure IC card, or “smart card”, that can be inserted and removed from a UE or other terminal equipment and that contains one or more software applications, such as a USIM, or a software program or module in the UE.

3GPP TS 22.259 describes PNM use cases that require establishment of secure links among locally connected devices of a PAN. An example depicted in Annex A.3 of TS 22.259 is a video service that originates in a PLMN, is routed through a PNE holding a USIM (e.g., a UE), and terminates in another PNE (e.g., a laptop computer). TS 22.259 requires a secure interface between the UE holding the USIM and other PNEs in the PAN, and both endpoints of the secured interface, which can be called a local interface, shall be mutually authenticated and authorized. As a secure interface, the local interface must be able to protect against eavesdropping and undetected modification attacks on security-related signalling data (e.g., authentication challenges and responses).

U.S. Patent Application Publication No. 2006/0182280 by Laitinen et al. states that it describes performing authentication in a communication system. A key is established with a terminal according to a key agreement protocol, and the key is tied to an authentication procedure. For example, digest authentication is combined with key exchange parameters in the payload of a digest message, in which a key is used as a password.

U.S. Pat. No. 7,142,674 to Brickell states that it describes a key exchange protocol that can be performed between components of a system, such as a computer and its peripheral devices. A peripheral device having user-input and display capabilities, such as a keyboard or mouse, can be used to confirm a key exchange between components with the user's entry of an amount of input data.

WO 02/065258 A2 by Johnson et al. states that it describes authenticating, over an unprotected channel, software having a unique identifier embedded in the memory of a responder. A challenger transmits a verify request and a unique nonce to the responder over the unprotected channel. The responder produces a hash digest from the nonce and the embedded software, and transmits the hash digest to the challenger, which produces its own verification hash digest and compares the received and verification hash digests.

3GPP TS 22.259 calls for mechanisms to establish a shared encryption key between the UICC Hosting Device (the UE in the example above) and other PNEs in the PAN. Nevertheless, the UICC Hosting Device may have a USIM that is not able to support secure interaction between the UICC and remote entities, but those devices should have a way to securely communicate with remote entities. Moreover, a PAN may include devices with communication capabilities that do not hold USIMs, and so for interoperability reasons, it would be beneficial if the mechanism to establish a shared encryption key between a UICC Hosting Device and a remote device is as agnostic as possible with respect to the nature of the remote device.

### SUMMARY

In accordance with aspects of this invention, there is provided a method of generating a shared key in a system of plural electronic processing devices. The method includes the steps of selecting, by a first electronic processing device, a first nonce value; sending the first nonce value to a second electronic processing device; selecting, by the second electronic processing device, a second nonce value; computing, by the second electronic processing device, a value of a cryptographic hash function of the first nonce value and an identifier of the first electronic processing device; sending the value of the cryptographic hash function to the first electronic device; determining, by a third electronic processing device, a shared key based on a secret value shared by the first and third electronic processing devices and on the first and second nonce values and the identifier; sending the shared key via a protected communication channel to the second electronic processing device; and determining, by the first electronic processing device, the shared key based on the secret value, the first nonce value, and the value of the cryptographic hash function.

In accordance with further aspects of this invention, there is provided an apparatus for generating a shared key in a system of plural electronic processing devices. The apparatus includes a first electronic processing device configured to select a first nonce value; a second electronic processing device configured to select a second nonce value, to receive the first nonce value selected by the first electronic processing device, to compute a value of a cryptographic hash function of the first nonce value and an identifier of the first electronic processing device, and to send the value of the cryptographic hash function to the first electronic device; and a third electronic processing device configured to determine a shared key and to send the shared key via a protected communication channel to the second electronic processing device. The shared key is based on a secret value that is shared by the first and third electronic processing devices and on the first and second nonce values and the identifier. The first electronic processing device is configured to determine the shared key based on the secret value, the first nonce value, and the value of the cryptographic hash function.

### BRIEF DESCRIPTION OF THE DRAWINGS

The various features, objects, and advantages of this invention will become apparent by reading this description in conjunction with the drawings, in which:

FIG. 1 is a block diagram of a portion of a communication system;

FIG. 2 is a flow chart of a method of generating a shared key; and

FIG. 3 depicts a key exchange procedure based on a generic bootstrapping architecture.

### DETAILED DESCRIPTION

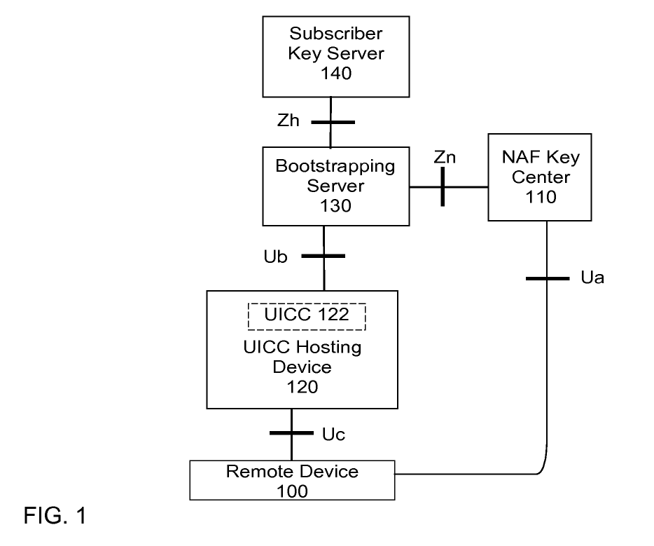

FIG. 1 is a block diagram of a portion of a PLMN that can implement shared-key establishment mechanisms in accordance with this invention. A Remote Device 100 is able to communicate with a Network Application Function (NAF) Key Center 110 via an interface Ua and with a UICC Hosting Device 120 having a UICC 122 via a local interface Uc. Communication over the local interface Uc can take place in any of several ways, such as wirelessly (e.g., via Bluetooth, Near Field Communication (NFC), and Infrared (IR)) and wired (e.g., via Universal Serial Bus (USB) and a serial cable).

The Remote Device 100 may be a personal computer (PC), personal digital assistant (PDA), Terminal Equipment (TE), ME, MT, Peripheral Equipment (PE), or any other device that is connectable to the UICC Hosting Device via the local interface Uc. The Remote Device 100, which may be physically separate from the UICC Hosting Device 120, can correspond to a PNE as defined in 3GPP TS 22.259. A Remote Device 100 itself may host a UICC, but such a UICC would not typically be involved in the key establishment between the UICC Hosting Device 120 and the Remote Device 100.

The NAF Key Center 110 is a dedicated NAF that is in charge of establishing keys shared by UICC Hosting Devices and Remote Devices. The NAF Key Center can be located substantially anywhere provided that it can be suitably connected (e.g., via HTTP) to the Remote Device. For example, the NAF Key Center can be located in the PLMN, and may be co-located with a Mobile Switching Center (MSC) or a Home Location Register (HLR).

The UICC Hosting Device 120 is the entity that is physically connected to the UICC 122 used for key establishment between UICC Hosting Device 120 and Remote Device 100. For example, the UICC Hosting Device 120 may be an MT, an ME, etc.

The inventors have recognized that a UICC-based method, such as ME-based Generic Bootstrapping Architecture (GBA_ME) or GBA with UICC-based enhancements (GBA_U), is advantageously used to provision a shared key (which is called Ks_local_device in this application) to the UICC Hosting Device 120 and the Remote Device 100. The shared key is derived by the UICC Hosting Device 120 and the NAF Key Center 110 from a master key (which is called Ks_NAF in this application) that resides in the UICC Hosting Device 120 and in the NAF Key Center 110. GBA procedures are specified in 3GPP TS 33.220 V7.5.0, Generic Authentication Architecture (GAA), Generic Bootstrapping Architecture (Release 7) (September 2006).

A GBA procedure requires a protocol interaction between the UICC Hosting Device 120 and a Bootstrapping Server 130 that takes place over a remote interface Ub. According to 3GPP TS 33.220, the Server 130 is, or its functionality is hosted in, a network element under the control of a Mobile Network Operator (MNO). The GBA procedure is based on secret parameters stored protected on a UICC 122, and so the procedure works only with devices that hold UICCs. The NAF Key Center 110 also communicates with the Bootstrapping Server 130 over an interface Zn. The long-lived secret shared by the UICC 122 and the PLMN is handled by a Subscriber Key Server 140, which for example can be a Home Subscriber System (HSS) according to the 3GPP network architecture.

The NAF Key Center 110 securely delivers the shared key Ks_local_device to the Remote Device 100 through a Transport Layer Security (TLS) tunnel that is established between the NAF Key Center 110 and the Remote Device 100 on the interface Ua. The shared key Ks_local_device can then be used on the local interface Uc between the UICC Hosting Device 120 and the Remote Device 100.

In order to allow the UICC Hosting Device 120 to compute the shared key Ks_local_device, the Device 120 needs as an input parameter a device identifier Device_ID of the Remote Device 100. In order to ensure that different Remote Devices never share the same key with the UICC Hosting Device 120, each identifier Device_ID corresponds to only one respective Remote Device. It will be appreciated that an identifier of the Remote Device is used in the key derivation not only so that different Remote Devices share different keys with the UICC Hosting Device, but also to make sure that the key derived at the NAF Key Center is based on the authenticated ID of the Remote Device. If the Remote Device is a ME, MT, or UE, then the Remote Device identifier can be the International Mobile Station Equipment Identity (IMEI).

As the Remote Device identifier (Device_ID) is used as an input to compute the shared key Ks_local_device in the UICC Hosting Device 120 and in the NAF Key Center 110, the Remote Device identifier Device_ID needs to be available in both entities. The Remote Device identifier could be sent on the local interface Uc, protected or unprotected, to the UICC Hosting Device 120. If the Remote Device identifier is an IMEI, for example, then it could be that the IMEI is sent in clear text on the local interface Uc.

Because the local interface Uc can be either protected or unprotected, sending the Device_ID of the Remote Device 100 in clear text on the local interface Uc must be avoided in order ensure that the privacy of the Remote Device 100 is not compromised when the local interface is unprotected. The techniques described in this application can be used on the local interface Uc regardless of whether the local interface is protected or not, obtaining independence from any security protocols potentially provided.

The inventors have recognized that sending the Device_ID on the interface Uc can be avoided and yet the UICC Hosting Device 120 can still compute the shared key. As explained in more detail below, the Remote Device 100 computes a suitable function value of its Device_ID and a nonce value that it selects. The Remote Device 100 sends the function value to the UICC Hosting Device 120 via the local interface Uc, and the Device 120 computes another function value of the value received from Device 100 and another nonce value that it selects.

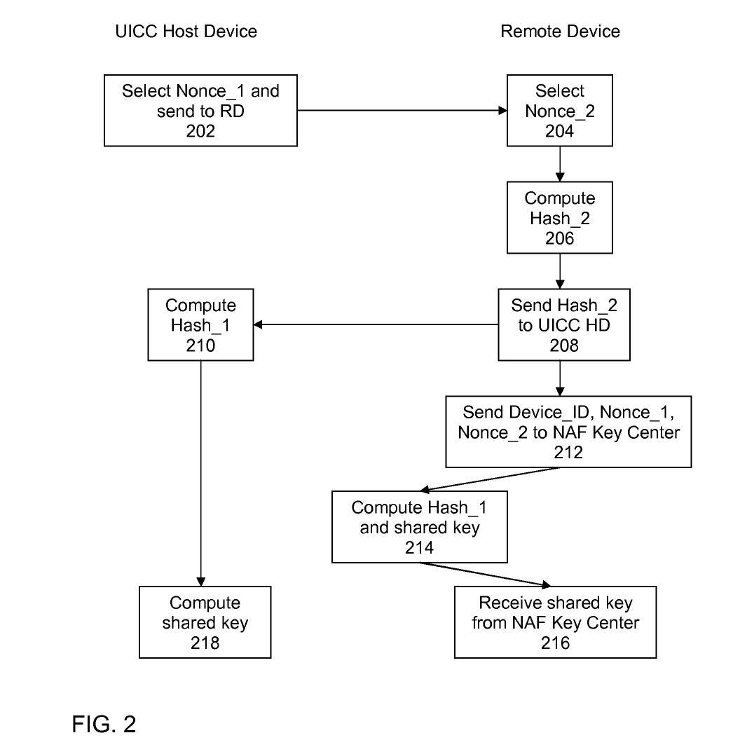

FIG. 2 is a flow chart of an exemplary method of generating a shared key. In step 202, the UICC Hosting Device 120 selects a Nonce_1 value, i.e., a random number generated by a suitable random-number source that has high statistical quality, and sends the Nonce_1 value to the Remote Device 100 via the local interface Uc. The random Nonce_1 value can be generated in many ways, e.g., by collecting random data from Device noise, radio noise, or keystrokes on a Device's key board, or by running a suitable pseudo-random generator (PRNG) algorithm on a processor in the Hosting Device 120. The Nonce_1 value may advantageously have a length of at least 64 bits.

In step 204, the Remote Device 100 selects a Nonce_2 value, i.e., a random number of suitable length, e.g., 64 bits.

In step 206, the Remote Device computes the value of a cryptographic hash function from its Device_ID and the Nonce_2 value. A typical cryptographic hash function takes a numeric string of any length as input and produces a fixed-length numeric string as output, sometimes called a “message digest” or a “digital fingerprint”. The hash value Hash_2 computed by the Remote Device 100 can be denoted as follows:

Hash_{—}2=H(Device_{—}ID∥Nonce_{—}2)

where H(x∥y) denotes a hash function of parameters x, y. According to the equation above, the Device_ID and Nonce_2 values are simply concatenated before computing the hash, but it will be understood that any one-way hash function with Device_ID and Nonce_2 as input parameters can be used. Suitable hash functions are known in the art, and include MD-5, SHA-1, SHA-256, and others.

In step 208, the Remote Device 100 sends the second hash value Hash_2 to the UICC Hosting Device 120 on the local interface Uc.

In step 210, the UICC Hosting Device 120 computes a first hash value Hash_1 of the Nonce_1 value and the second hash value Hash_2 received from the Remote Device. The first hash value Hash_1 can be denoted as follows:

Hash_{—}1=H(Hash_{—}2∥Nonce_{—}1)=H(H(Device_{—}ID∥Nonce_{—}2)∥Nonce_{—}1).

In step 212, the Remote Device 100 sends Device_ID, Nonce_1, and Nonce_2 to the NAF Key Center 110 using a protected communication channel, e.g., a TLS tunnel, on the interface Ua.

In step 214, the NAF Key Center 110 checks and authorizes the received Device_ID, computes the first hash value Hash_1 from the information received from the Remote Device 100, and computes the shared key Ks_local_device using its computed Hash_1 value and a secret shared with the UICC Hosting Device 120 as input.

In step 216, the Remote Device 100 receives the shared key sent by the NAF Key Center 110 through the protected communication channel on the interface Ua.

In step 218, the UICC Hosting Device 120 computes the shared key from its own copy of Hash_1.

It will be appreciated that the first hash value Hash_1 is a value that uniquely identifies the Remote Device 100 just as the value Device_ID does. It will thus be further appreciated that any suitable mathematical function of the three parameters Device_ID, Nonce_1, and Nonce_2 that produces a value that is unique to a Remote Device can be used in place of a hash function. It will be understood that to be “suitable”, it is necessary for such a mathematical function to be a one-way function.

If the Remote Device 100 and a UICC Hosting Device 120 already have a shared key Ks_local_device, then the Remote Device and UICC Hosting Device may attempt to use it. If a new shared key is needed, then the Remote Device 100 can send a request to the UICC Hosting Device 120 to establish a new shared key.

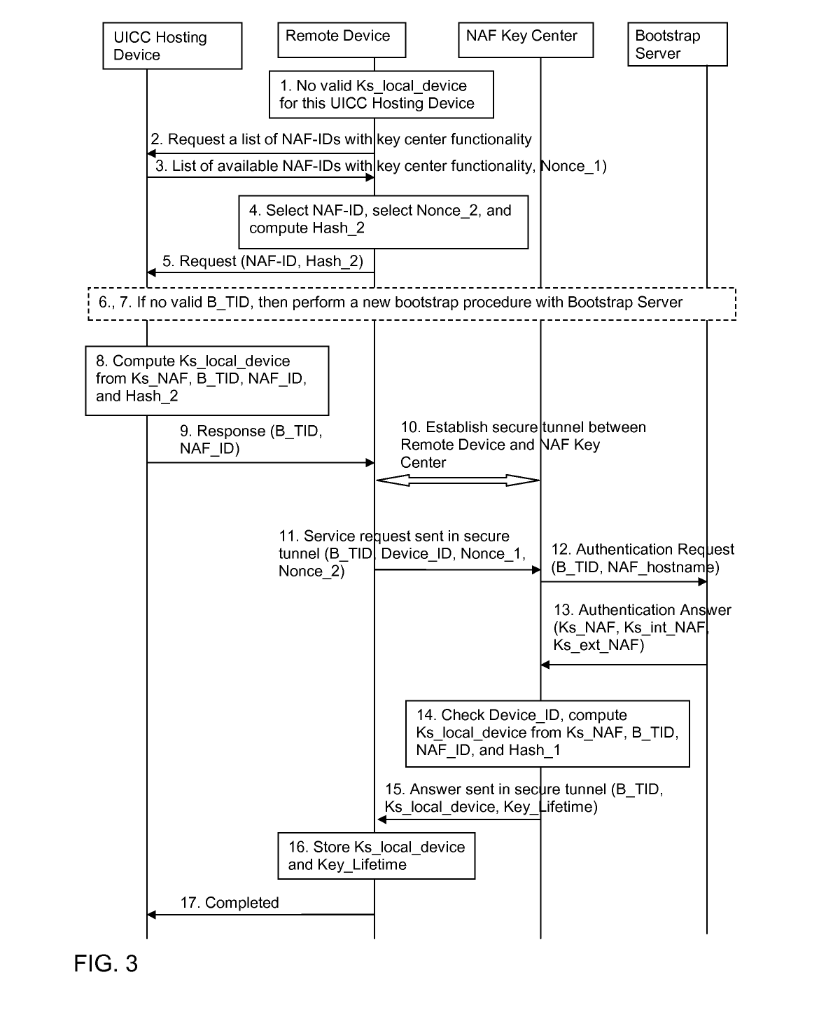

FIG. 3 depicts a GBA-based key exchange procedure that is in accordance with aspects of this invention.

1. The Remote Device 100 determines that it has not stored a valid Ks_local_device key for a UICC Hosting Device 120 to which the Remote Device is connected through the Uc interface.

2. The Remote Device 100 sends a request to the UICC Hosting Device 120 to identify one or more NAF Key Centers 110.

3. The UICC Hosting Device 120 sends the Remote Device 100 a list of one or more available NAF-IDs, which are identifiers for NAF entities that have NAF Key Center functionality. The UICC Hosting Device 120 generates a Nonce_1 value and sends it to the Remote Device 100.

4. The Remote Device 100 either selects a NAF-ID from the list received from the UICC Hosting Device 120 or proposes a NAF-ID, which may be stored in a memory in the Remote Device, to the UICC Hosting Device. The Remote Device 100 selects a Nonce_2 value and computes the Hash_2 value H(Device_ID II Nonce_2).

5. The Remote Device 100 sends a request to the UICC Hosting Device 120 for an identifier of a bootstrap key. Such an identifier is a Bootstrapping Transaction Identifier (B-TID), i.e., a B_TID value. The Remote Device 100 sends the parameters NAF_ID and Hash_2 to the UICC Hosting Device 120 in order for the Device 120 to be able to compute a new shared key Ks_local_device.

6. If the UICC Hosting Device 120 already has a valid bootstrap key, that key is identified by the B_TID value. If the UICC Hosting Device 120 does not have a valid bootstrap key, then the Device 120 performs a new bootstrapping procedure, and the identifier of the key generated by that new bootstrapping procedure is identified by the B_TID value. If a new bootstrapping procedure is needed, the UICC Hosting Device 120 asks for a complete GBA run, i.e., a GBA bootstrapping procedure and a GBA_ME procedure or a GBA_U—NAF Derivation procedure for example.

7. After completion of the GBA run, the UICC Hosting Device 120 holds a secret value Ks_NAF that is also held by the NAF Key Center 110.

8. The UICC Hosting Device 120 computes the Hash_1 value using its Nonce_1 value, and computes the shared key Ks_local_device from its Ks_NAF value, the B_TID value, the NAF_ID value, and the Hash_1 value. The UICC Hosting Device 120 locally stores the shared key Ks_local_device.

9. The UICC Hosting Device 120 sends the B_TID value and the NAF_ID value to the Remote Device 100, e.g., through the interface Uc.

10. The Remote Device 100 and the NAF Key Center 110, i.e., the node in the network that has NAF Key Center functionality, establish a secure communication link, e.g., an HTTPS tunnel with certificate-based mutual authentication, on interface Ua.

11. The Remote Device 100 sends a suitable “service request” message to the NAF Key Center 110 on the secure link. The service request message includes the B_TID value, the Remote Device identifier Device_ID, the Nonce_1 value, and the Nonce_2 value, which the NAF Key Center 110 uses to compute the shared key Ks_local_device.

12. The NAF Key Center 110 sends the B_TID value to the Bootstrapping Server 130 in a credential request through the interface Zn.

13. The Bootstrapping Server 130 replies to the credential request by sending the secret Ks_NAF to the NAF Key Center 110, as well as other information items, such as Ks_int_NAF and Ks_ext_NAF that are used by the GBA_U method and respectively located in the UICC and ME. Information items such as a bootstrap time and a key lifetime may also be included in the reply.

14. The NAF Key Center 110 computes the Hash_1 value from the Device_ID, Nonce_1, and Nonce_2 values received from the Remote Device 100. The NAF Key Center also computes the shared key Ks_local_device from the KS_NAF, B_TID, NAF_ID, and Hash_1 values, and locally stores the shared key Ks_local_device. It should be understood that the Center 110 locally stores the shared key for back-up purposes, e.g., just in case the Remote Device “loses” the shared key. Such local storage is an advantageous option but it is not always necessary.

15. The NAF Key Center 110 replies to the Remote Device's service request message by sending a suitable response message to the Remote Device 100 through the secure communication link. The response message includes the B_TID and the shared key Ks_local_device, and also typically includes a Key_Lifetime value that indicates a lifetime of the shared key. Upon expiration of the lifetime, the shared key is no longer valid.

16. The Remote Device 100 locally stores the shared key Ks_local_device and associated Key_Lifetime value received from the NAF Key Center 110.

17. The Remote Device 100 sends a suitable message to the UICC Hosting Device 120 to indicate that the procedure for establishing the shared key Ks_local_device has been completed, and thus that the Devices 100, 120 can communicate securely through the Uc interface.

Using the techniques described in this application, the unique identifier Device_ID of the Remote Device 100 is not sent in clear text on the local interlace between the Device 100 and the UICC Hosting Device 120, but the shared-key establishment procedure is still based on the unique Remote Device identifier. Thus, secure binding between the established key and the Device identifier is achieved. Moreover, the identifier Device_ID is not even exposed to the UICC Hosting Device 120.

The Remote Device 100 cannot select a Nonce_1 value on behalf of the UICC Hosting Device that is different from the Nonce_1 value selected by the UICC Hosting Device 120 because doing so would result in a shared key Ks_local_device computed by the Remote Device 100 that is different from the shared key Ks_local_device computed by the UICC Hosting Device 120. This ensures that the shared key is established based on random parameters from both the UICC Hosting Device 120 and the Remote Device 100, thereby increasing confidence in the random numbers on which the shared key is based.

It is expected that this invention can be implemented in a wide variety of environments, including for example mobile communication devices. It will be appreciated that procedures described above are carried out repetitively as necessary. To facilitate understanding, many aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both. Many communication devices can easily carry out the computations and determinations described here with their programmable processors and application-specific integrated circuits.

Moreover, the invention described here can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a RAM, a ROM, an erasable programmable read-only memory (EPROM or Flash memory), and an optical fiber.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action.

It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A method of generating a shared key in a system of plural electronic processing devices, comprising the steps of:
selecting, by a first electronic processing device, a first nonce value;
sending the first nonce value to a second electronic processing device;
selecting, by the second electronic processing device, a second nonce value;
computing, by the second electronic processing device, a value of a cryptographic hash function of the first nonce value and an identifier of the first electronic processing device;
sending the value of the cryptographic hash function to the first electronic device;
determining, by a third electronic processing device, a shared key, wherein the shared key is based on a secret value that is shared by the first and third electronic processing devices and on the first and second nonce values and the identifier;
sending the shared key via a protected communication channel to the second electronic processing device;
determining, by the first electronic processing device, the shared key, wherein the shared key is based on the secret value, the first nonce value, and the value of the cryptographic hash function.

2. The method of claim 1, wherein the system is a communication system, the first electronic processing device is a UICC Hosting Device, the second electronic processing device is a Remote Device, and the third electronic processing device is a NAF Key Center.

3. The method of claim 1, wherein the first and second nonce values are pseudo-random numbers, each having a length of at least 64 bits.

4. The method of claim 1, wherein the cryptographic hash function is one of MD-5, SHA-1, and SHA-256.

5. The method of claim 1, wherein the protected communication channel is a transport layer security tunnel.

6. An apparatus for generating a shared key in a system of plural electronic processing devices, comprising:
a first electronic processing device configured to select a first nonce value;
a second electronic processing device configured to select a second nonce value, to receive the first nonce value selected by the first electronic processing device, to compute a value of a cryptographic hash function of the first nonce value and an identifier of the first electronic processing device, and to send the value of the cryptographic hash function to the first electronic device; and
a third electronic processing device configured to determine a shared key and to send the shared key via a protected communication channel to the second electronic processing device, wherein the shared key is based on a secret value that is shared by the first and third electronic processing devices and on the first and second nonce values and the identifier;
wherein the first electronic processing device is configured to determine the shared key based on the secret value, the first nonce value, and the value of the cryptographic hash function.

7. The apparatus of claim 6, wherein the system is a communication system, the first electronic processing device is a UICC Hosting Device, the second electronic processing device is a Remote Device, and the third electronic processing device is a NAF Key Center.

8. The apparatus of claim 6, wherein the first and second nonce values are pseudo-random numbers, each having a length of at least 64 bits.

9. The apparatus of claim 6, wherein the cryptographic hash function is one of MD-5, SHA-1, and SHA-256.

10. The apparatus of claim 6, wherein the protected communication channel is a transport layer security tunnel.
